(19) United States
(12) Patent Application Publication
(10) Pub. No.: US 2008/0163772 A1
(43) Pub. Date: Jul. 10, 2008

(54) Register Adjusting Apparatus for Rotating Body

(76) Inventor: Akehiro Kusaka, Chiba (JP)

Correspondence Address: BIRCH STEWART KOLASCH & BIRCH, PO BOX 747, FALLS CHURCH, VA, 22040-0747, US

(21) Appl. No.: 11/885,641

(22) PCT Filed: May 18, 2006
(86) PCT No.: PCT/JP2006/309900

§ 371 Date: Sep. 5, 2007

(30) Foreign Application Priority Data
May 20, 2005 (JP) 2005-147583

(51) Int. Cl. B41F 13/24

(52) U.S. Cl. 101/248

(57) ABSTRACT

A register adjusting apparatus for a rotating body, which can easily perform register adjustment while enabling motor driving with an inexpensive mechanical configuration, is provided. The register adjusting apparatus comprises: a pair of inner bearings (4, 6) rotatably supporting opposite end portions of a plate cylinder (7), and provided at a position eccentric by the same amount with respect to the axis of the plate cylinder; cylinders (11A, 11B) for pivoting the inner bearings; an outer bearing (3) supporting one of the inner bearings (4), and eccentric with respect to the center of the inner bearing; a motor (15) for pivoting the outer bearing; a motor (70), provided on a shaft end (7B) of the plate cylinder on the side of the other inner bearing (6), for rotationally driving the plate cylinder; and a pin (73) provided in the inner bearing (6) and engaging a slot (72) of the motor, and the slot permits movement of the plate cylinder which is moved when driven by the motor (15).

### TECHNICAL FIELD

This invention relates to a register adjusting apparatus in a rotary printing press, which adjusts the register of a printing plate mounted on a rotating body, such as a plate cylinder, in a circumferential direction, a lateral direction, or a cocking direction.

### BACKGROUND ART

With this type of rotary printing press, techniques for driving cylinder devices, such as a plate cylinder, a blanket cylinder, and an impression cylinder, by a motor for each cylinder, instead of a gear-driven mode, have been proposed in recent years with the increase in the control accuracy of motors and the progress of their structures. Such a technique is proposed, for example, by Patent Document 1.

According to this technique, the number of components, such as gears, and the man-hours for assembly can be cut down, and an adjusting operation for printing can be simplified.

Patent Document 1: Japanese Unexamined Patent Publication No. 1998-67089

### DISCLOSURE OF THE INVENTION

### Problems to be Solved by the Invention

As the functions of a plate cylinder as a rotating body in a rotary printing press, it is required to perform (1) lateral movement (moving the plate cylinder in the axial direction), (2) circumferential movement (turning the plate cylinder in the circumferential direction to shift its phase relative to other cylinder) and (3) cocking (tilting the plate cylinder), each of these movements intended for register adjustment, and also perform (4) center-to-center adjustment (contact pressure adjustment: adjusting the distance to other cylinder with the use of an eccentric bearing), and (5) throw-on and throw-off movement (making or cutting off contact with other cylinder with the use of an eccentric bearing).

However, the driving of the plate cylinder by a motor while fulfilling the above-mentioned functions has required the adoption of a special coupling or a special gear connection. Thus, the number of the components cannot be cut down, and mounting with high accuracy is difficult, posing the problem that this method is not feasible.

The present invention has been proposed in the light of the foregoing circumstances, and it is an object of the present invention to provide a register adjusting apparatus for a rotating body, which can easily perform register adjustment while enabling motor driving with an inexpensive mechanical configuration.

### Means for Solving the Problems

The register adjusting apparatus for a rotating body according to the present invention, for solving the above-mentioned problems, is one comprising:

cocking eccentric bearing means for supporting at least a one-side shaft of the rotating body;

first drive means for pivoting the cocking eccentric bearing means;

a motor, provided on a shaft portion of the rotating body, for rotationally driving the rotating body; and

an engaging portion engaging an engaged portion of the motor, and

wherein the engaged portion permits movement of the motor in accordance with movement of the rotating body which is moved in a cocking direction by driving of the first drive means located on the one side.

The register adjusting apparatus for a rotating body is that wherein

the cocking eccentric bearing means is composed of one-side and opposite-side cocking eccentric bearings for supporting the one-side shaft and an opposite-side shaft of the rotating body, and

which further comprises the first drive means located on one side and an opposite side for pivoting the one-side and opposite-side cocking eccentric bearings.

The register adjusting apparatus for a rotating body is that wherein

the cocking eccentric bearing means is a one-side cocking eccentric bearing for supporting the one-side shaft, and

which further comprises

a one-side throw-on and throw-off eccentric bearing supporting the one-side shaft of the rotating body and supported by the one-side cocking eccentric bearing,

an opposite-side throw-on and throw-off eccentric bearing for supporting the opposite-side shaft of the rotating body, and

third drive means for pivoting the one-side throw-on and throw-off eccentric bearing and the opposite-side throw-on and throw-off eccentric bearing.

The register adjusting apparatus for a rotating body is that further comprising

a one-side throw-on and throw-off eccentric bearing supporting the one-side shaft of the rotating body and supported by the one-side cocking eccentric bearing,

an opposite-side throw-on and throw-off eccentric bearing supporting the opposite-side shaft of the rotating body and supported by the opposite-side cocking eccentric bearing, and

third drive means for pivoting the one-side throw-on and throw-off eccentric bearing and the opposite-side throw-on and throw-off eccentric bearing.

The register adjusting apparatus for a rotating body is that wherein the engaged portion is moved with respect to the engaging portion by the first drive means.

The register adjusting apparatus for a rotating body is that wherein the motor includes

a rotating portion rotated by a drive action, and

a support portion supporting the rotating portion and having the engaged portion formed therein.

The register adjusting apparatus for a rotating body is that wherein the engaged portion is restrained by the engaging portion to prevent rotation of the support portion.

The register adjusting apparatus for a rotating body is that wherein

the engaged portion is a slot or a long groove or a pin, and

the engaging portion is a pin engaging into the slot or the long groove, or is a slot or a long groove which the pin engages.

The register adjusting apparatus for a rotating body is that wherein

the slot or the long groove has a major axis dimension in a moving direction of the rotating body moved by an action of the first drive means.

The register adjusting apparatus for a rotating body is that wherein the motor includes

a rotating portion rotated by a drive action, and

a support portion supporting the rotating portion and having the engaged portion formed therein, and

which further comprises phase difference correction means for correcting a rotation phase shift of the rotating body caused by pivoting of the one-side and opposite-side throw-on and throw-off eccentric bearings in accordance with an action of the third drive means.

The register adjusting apparatus for a rotating body is that wherein the motor includes

a rotating portion rotated by a drive action, and

a support portion supporting the rotating portion and having the engaged portion formed therein, and

which further comprises phase difference correction means for correcting a rotation phase shift of the rotating body caused by pivoting of the cocking eccentric bearing means in accordance with an action of the first drive means.

The register adjusting apparatus for a rotating body is that wherein said phase difference correction means comprises

a sensor for detecting a phase of the rotating body, and

control means for controlling the motor based on a detection signal of the sensor.

The register adjusting apparatus for a rotating body is that wherein

the motor is provided on the opposite-side shaft of the rotating body, and has a slot or a long groove formed in the support portion,

an eccentric pin is provided which is pivotably supported by the opposite-side throw-on and throw-off eccentric bearing and which engages the slot or the long groove, and

the phase difference correction means comprises

a sensor for detecting a phase of the rotating body,

a motor for pivoting the eccentric pin, and

control means for controlling the motor based on a detection signal of the sensor.

The register adjusting apparatus for a rotating body is that wherein

the motor is provided on the opposite-side shaft of the rotating body, and has a slot or a long groove formed in the support portion,

an eccentric pin is provided which is pivotably supported by the opposite-side cocking eccentric bearing and which engages the slot or the long groove, and

the phase difference correction means comprises

a sensor for detecting a phase of the rotating body,

a motor for pivoting the eccentric pin, and

control means for controlling the motor based on a detection signal of the sensor.

The register adjusting apparatus for a rotating body is that wherein

the motor is provided on the opposite-side shaft of the rotating body, and has a slot or a long groove formed in the support portion,

a pin is provided which has a proximal end portion slidably supported by the opposite-side throw-on and throw-off eccentric bearing and which engages the slot or the long groove, and

the phase difference correction means comprises

a sensor for detecting a phase of the rotating body,

a motor for moving the pin, and

control means for controlling the motor based on a detection signal of the sensor.

The register adjusting apparatus for a rotating body is that wherein

the motor is provided on the opposite-side shaft of the rotating body, and has a slot or a long groove formed in the support portion,

a pin is provided which has a proximal end portion slidably supported by the opposite-side cocking eccentric bearing and which engages the slot or the long groove, and

the phase difference correction means comprises

a sensor for detecting a phase of the rotating body,

a motor for pivoting the pin, and

control means for controlling the motor based on a detection signal of the sensor.

Furthermore, the register adjusting apparatus for a rotating body according to the present invention is a register adjusting apparatus for a rotating body, comprising:

a pair of bearings for rotatably supporting opposite end portions of a rotating body;

a motor, provided on a shaft portion of the rotating body beside the bearing on an opposite side, for rotationally driving the rotating body;

second drive means, provided beside the bearing on one side, for moving the rotating body, together with the motor, in an axial direction; and

an engaging portion provided on the bearing on the opposite side, and engaging an engaged portion of the motor, and

wherein the engaged portion permits movement of the rotating body which is moved in the axial direction when driven by the second drive means.

The register adjusting apparatus for a plate cylinder is that wherein the engaged portion is moved with respect to the engaging portion by the second drive means.

The register adjusting apparatus for a plate cylinder is that wherein the engaged portion is moved with respect to the engaging portion by the second drive means, with the engaged portion being engaged with the engaging portion.

The register adjusting apparatus for a rotating body is that wherein

the pair of bearings are a pair of throw-on and throw-off eccentric bearings eccentric with respect to the rotating body, and

which further comprises third drive means for pivoting the pair of throw-on and throw-off eccentric bearings.

The register adjusting apparatus for a rotating body is that wherein the motor includes

a rotating portion rotated by a drive action, and

a support portion supporting the rotating portion and having the engaged portion formed therein.

The register adjusting apparatus for a rotating body is that wherein the engaged portion is restrained by the engaging portion to prevent rotation of the support portion.

The register adjusting apparatus for a rotating body is that wherein

the engaged portion is a hole or a groove or a pin, and

the engaging portion is a pin engaging into the hole or the groove, or is a hole or a groove which the pin engages.

The register adjusting apparatus for a rotating body is that wherein the motor includes

a rotating portion rotated by a drive action, and

a support portion supporting the rotating portion and having the engaged portion formed therein, and

which further comprises phase difference correction means for correcting a rotation phase shift of the rotating body caused by pivoting of the pair of throw-on and throw-off eccentric bearings in accordance with an action of the third drive means.

The register adjusting apparatus for a rotating body is that wherein the phase difference correction means comprises

a sensor for detecting a phase of the rotating body, and

control means for controlling the motor based on a detection signal of the sensor.

The register adjusting apparatus for a rotating body is that wherein

the motor is provided on the opposite-side shaft of the rotating body, and has a hole or a groove formed in the support portion,

an eccentric pin is provided which is pivotably supported by the opposite-side throw-on and throw-off eccentric bearing and which engages the hole or the groove, and

the phase difference correction means comprises

a sensor for detecting a phase of the rotating body,

a motor for pivoting the eccentric pin, and

control means for controlling the motor based on a detection signal of the sensor.

The register adjusting apparatus for a rotating body is that wherein

the motor is provided on the opposite-side shaft of the rotating body, and has a hole or a groove formed in the support portion,

a pin is provided which has a proximal end portion slidably supported by the opposite-side throw-on and throw-off eccentric bearing and which engages the hole or the groove, and

the phase difference correction means comprises

a sensor for detecting a phase of the rotating body,

a motor for pivoting the pin, and

control means for controlling the motor based on a detection signal of the sensor.

### EFFECTS OF THE INVENTION

The motor for rotationally driving the rotating body can be supported on the frame, and it becomes possible to permit the movement of the rotating body in the cocking (tilting) direction in the range of the major axis dimension L2.

Furthermore, the motor for rotationally driving the rotating body can be supported on the frame, and it becomes possible to permit the movement of the rotating body in the lateral direction in the range of the depth dimension L1.

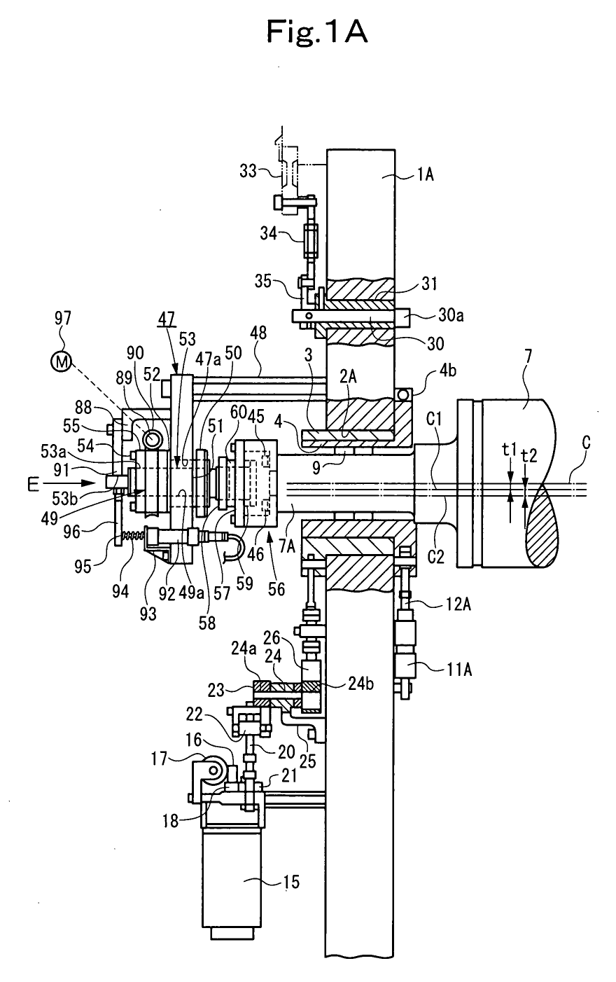

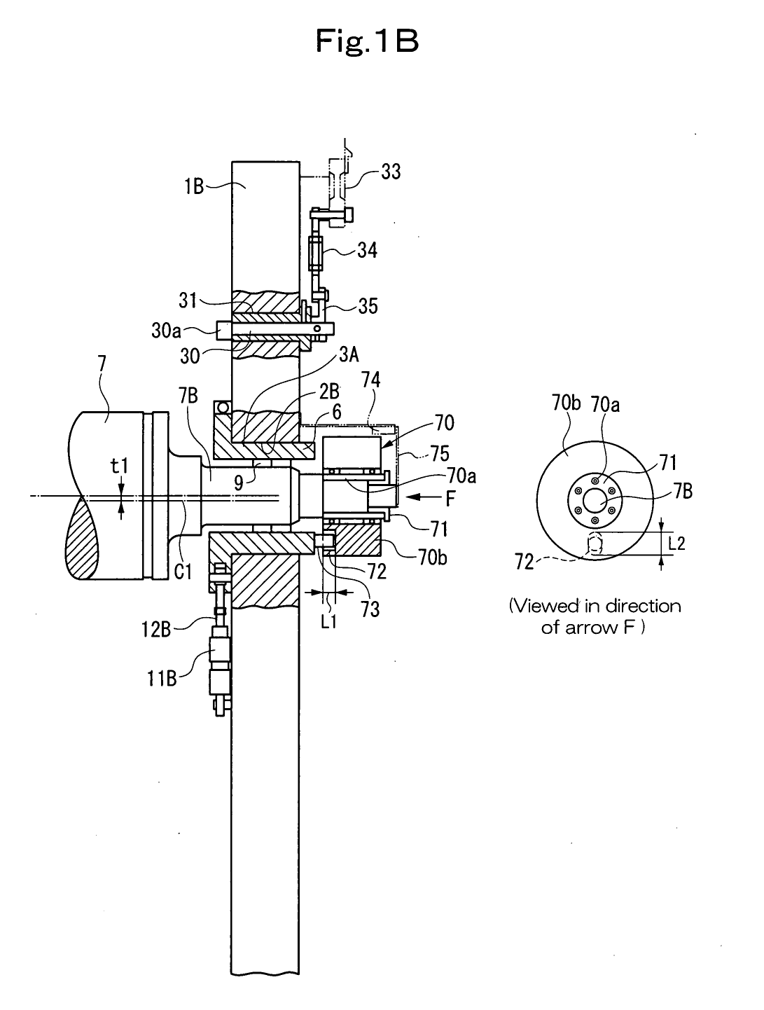

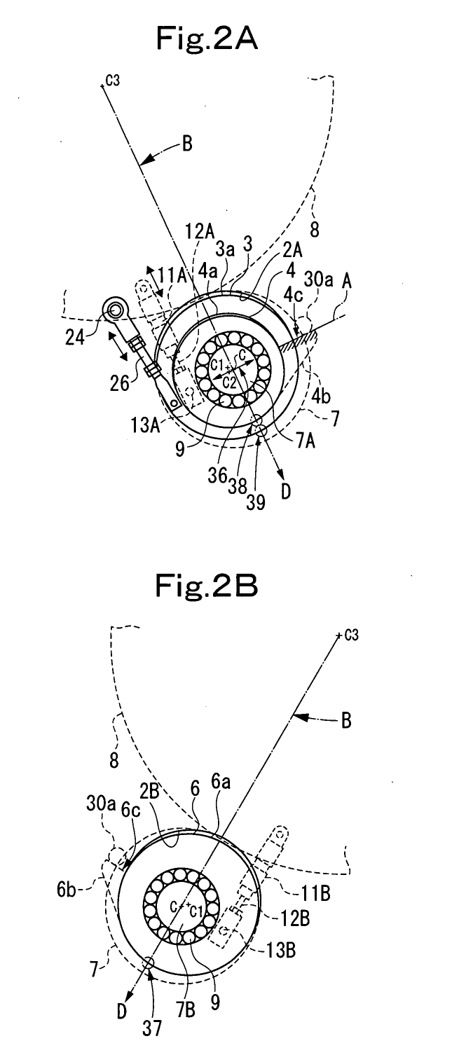

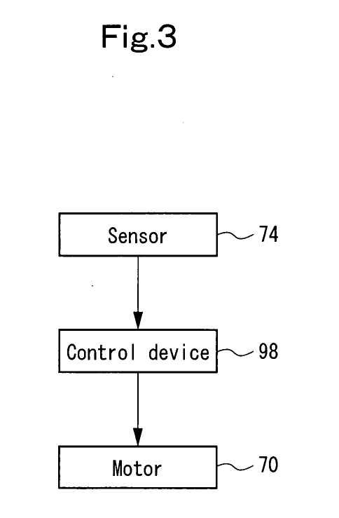

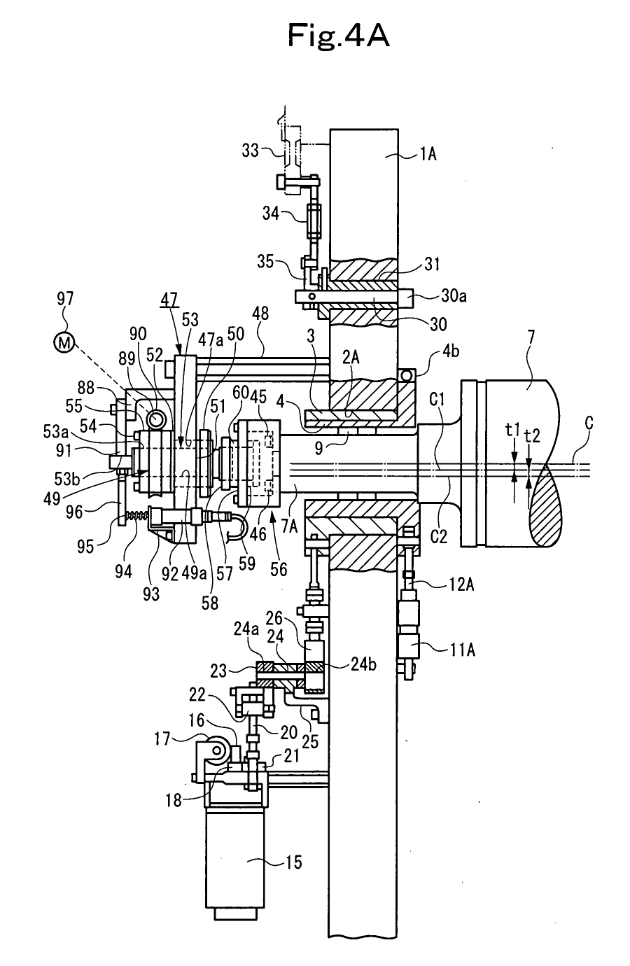

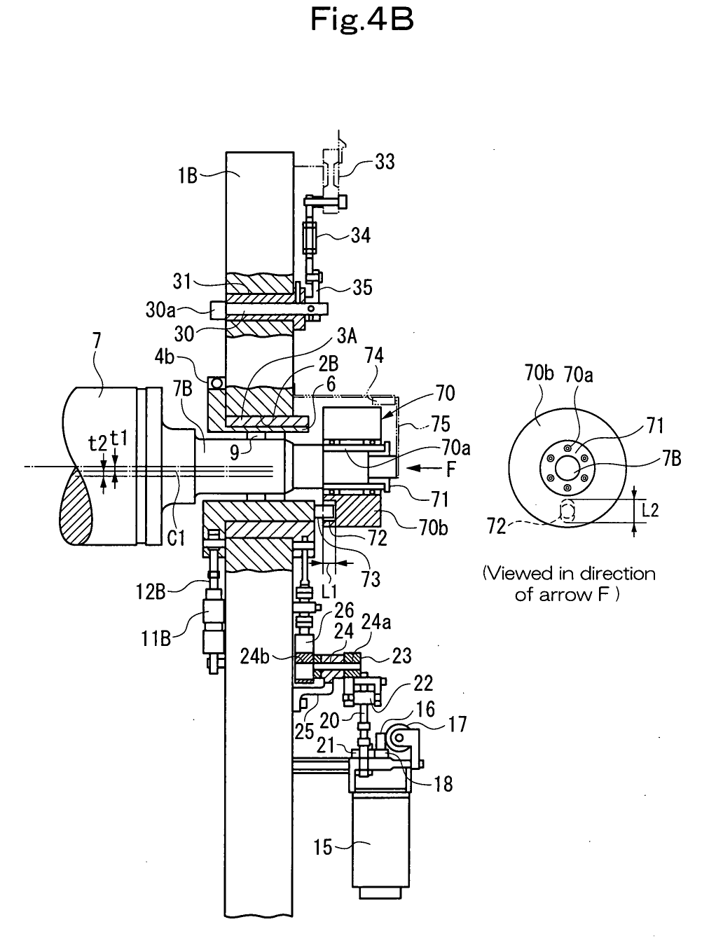

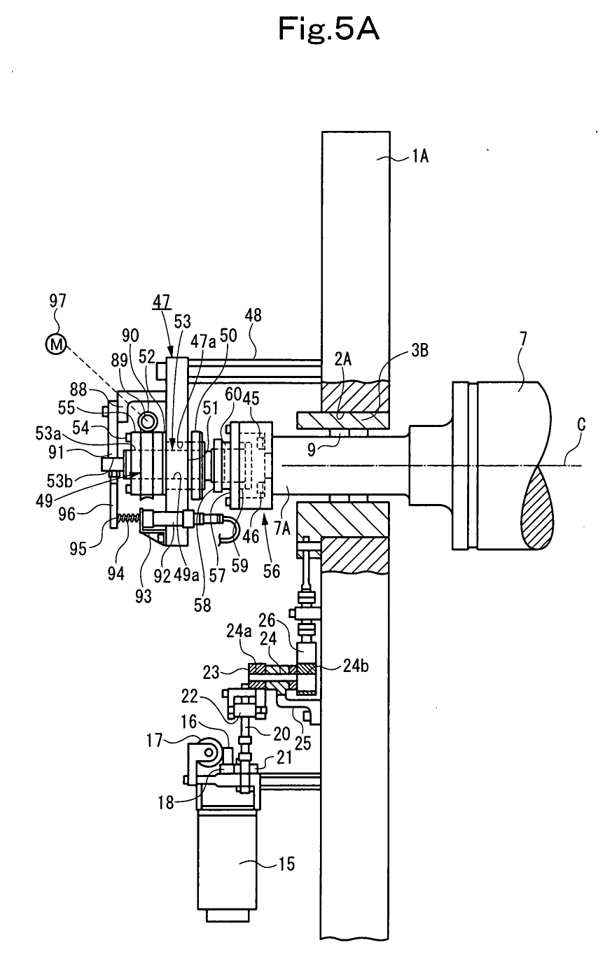

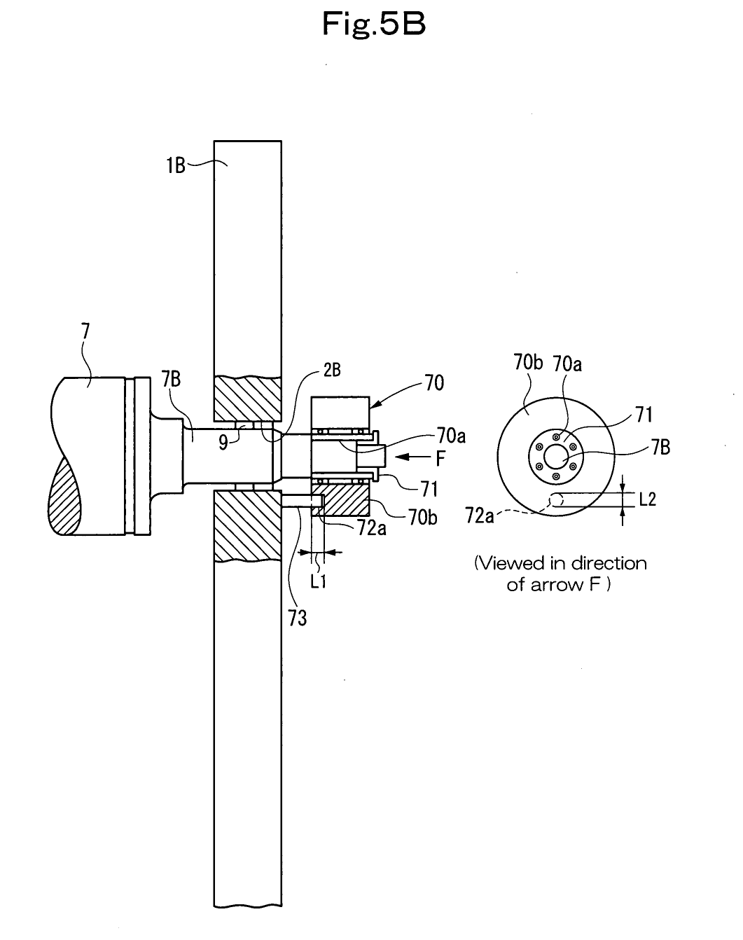

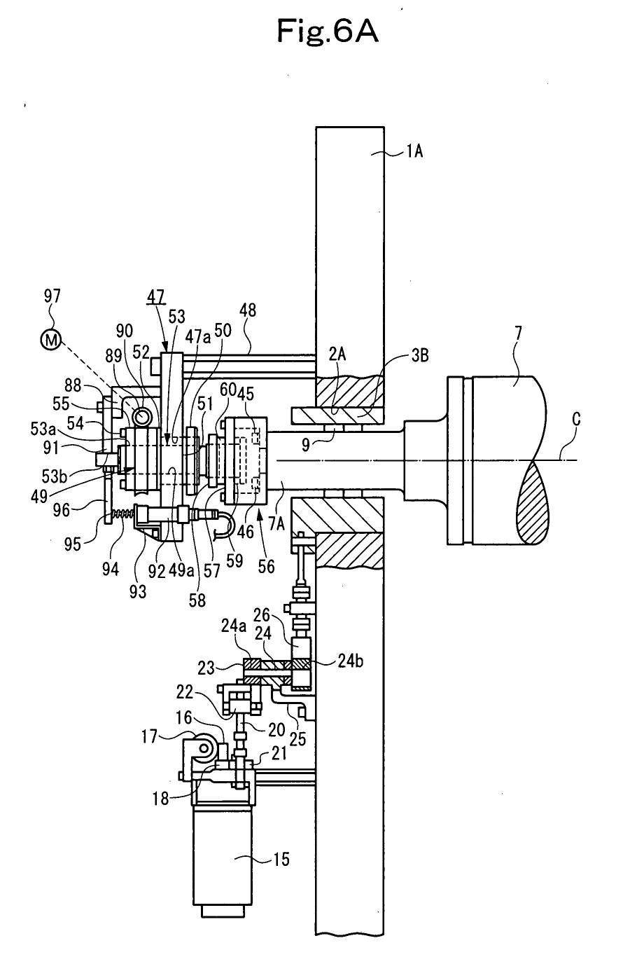

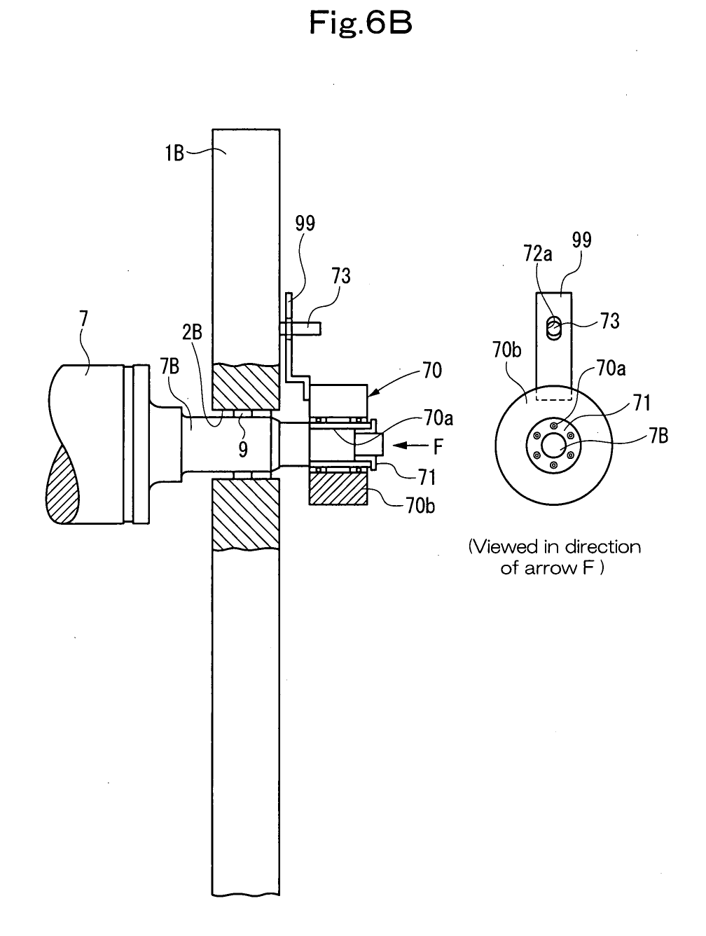

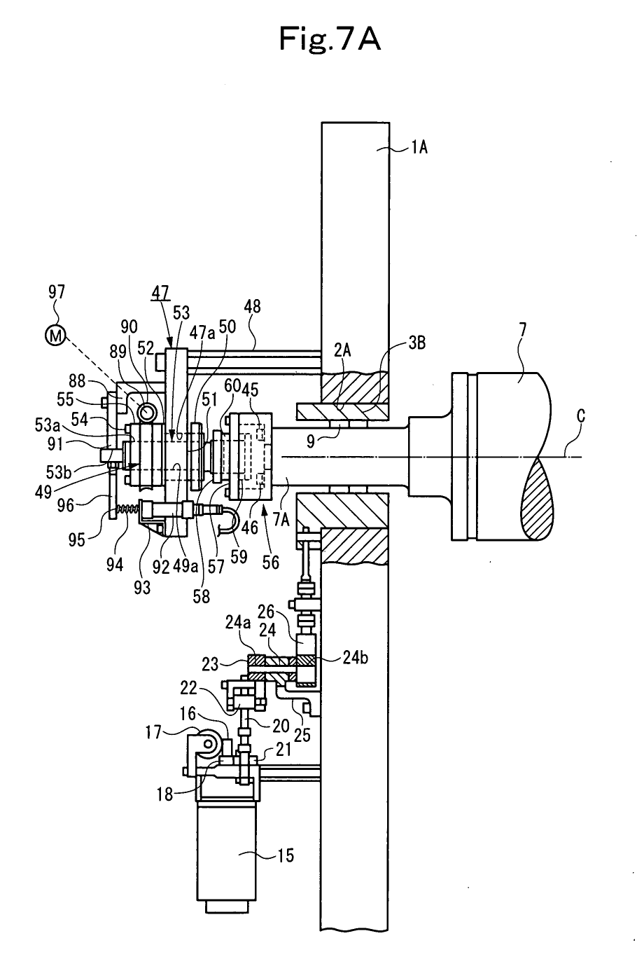

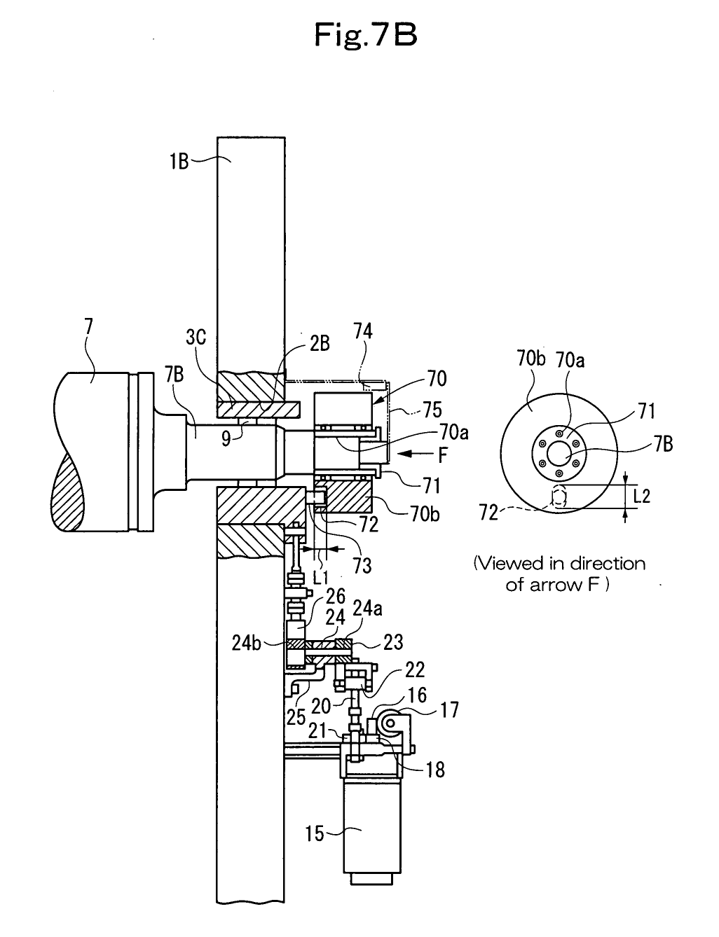

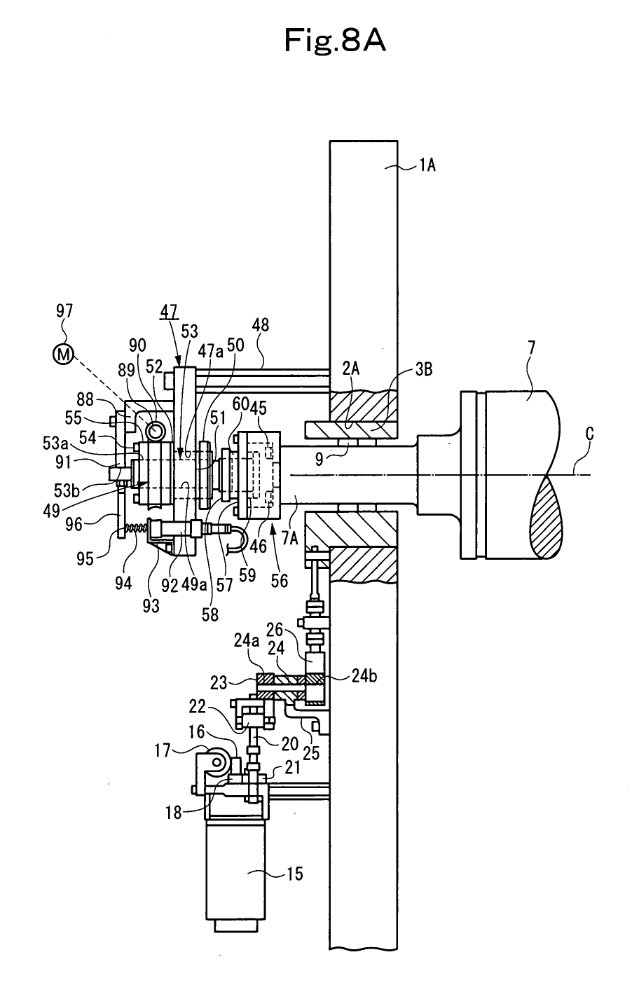

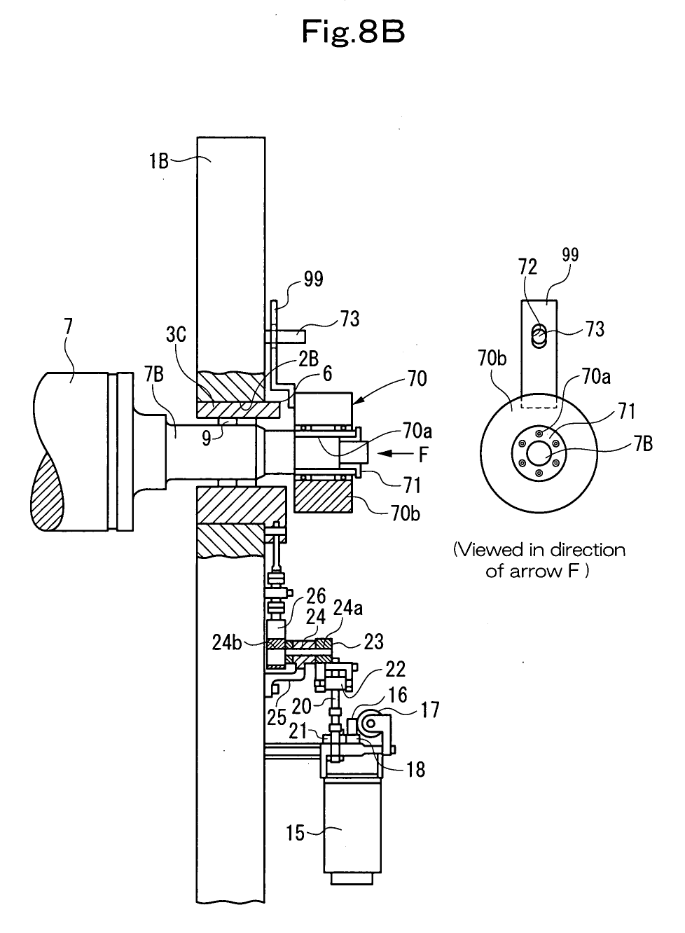

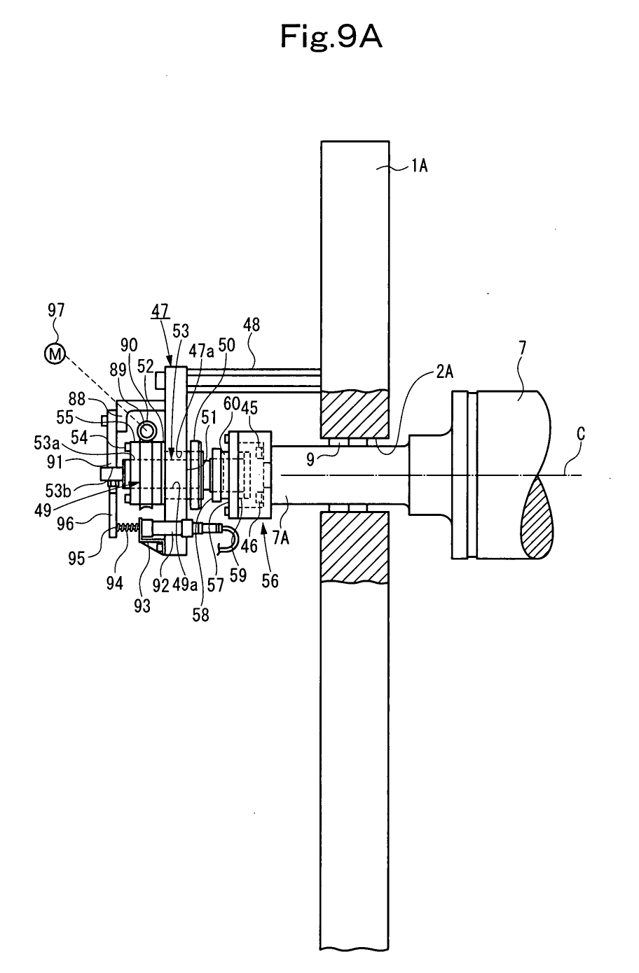

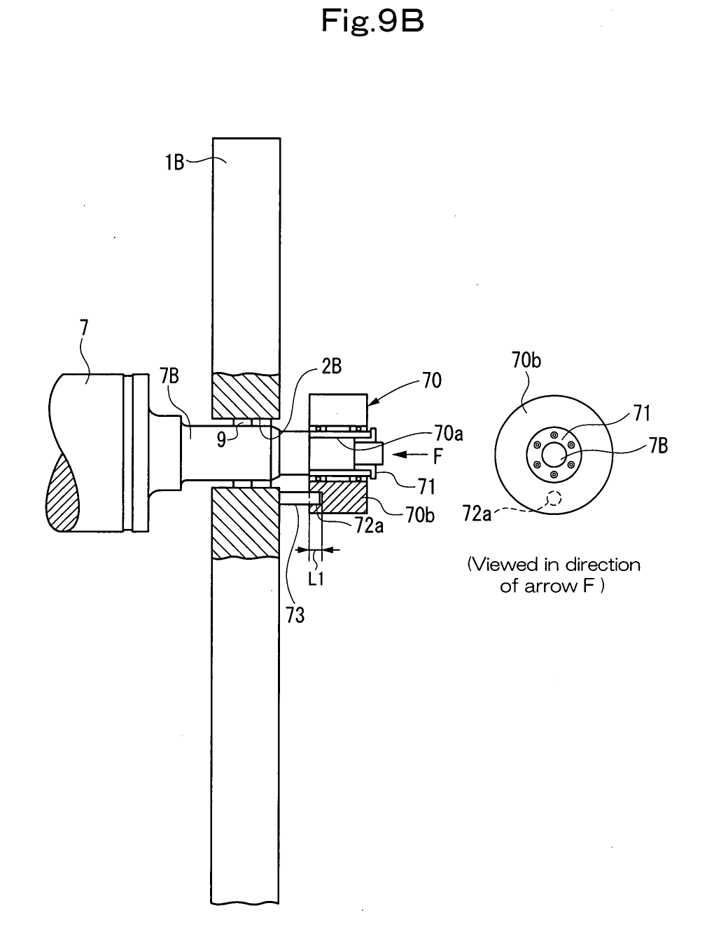

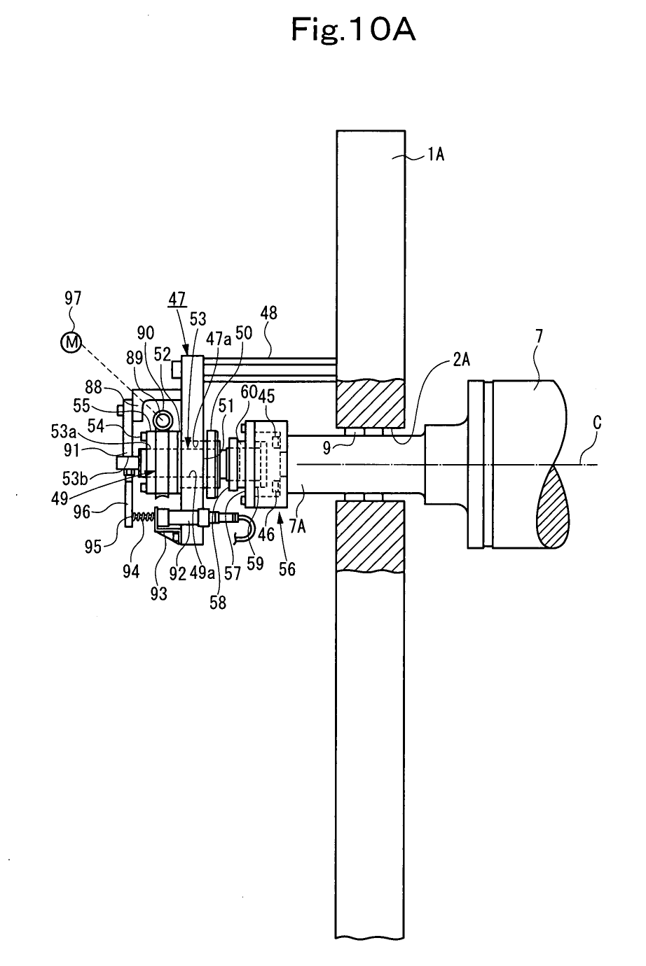

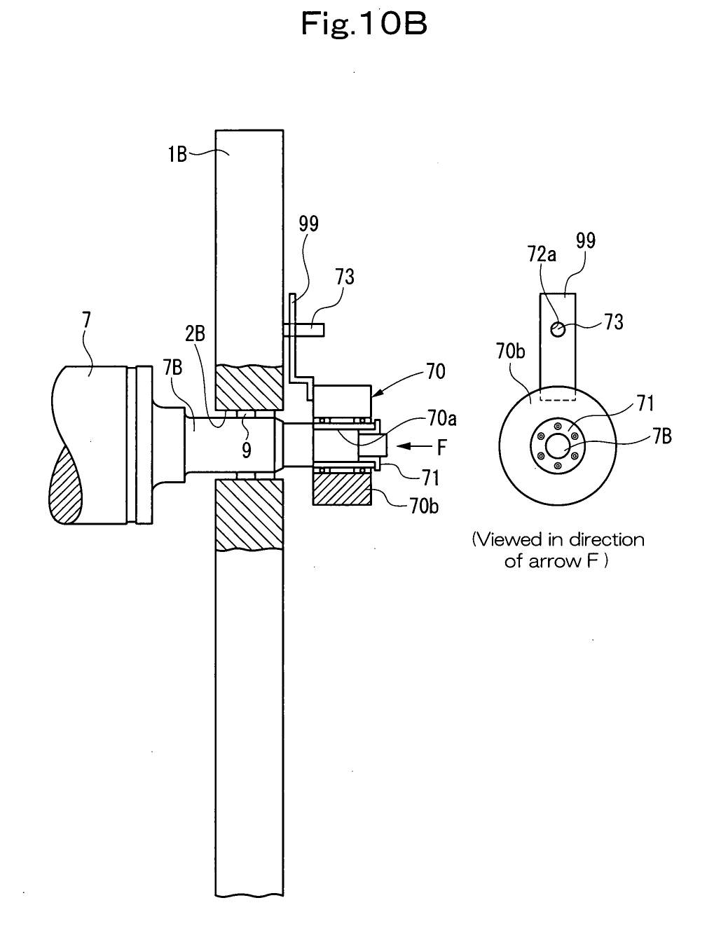

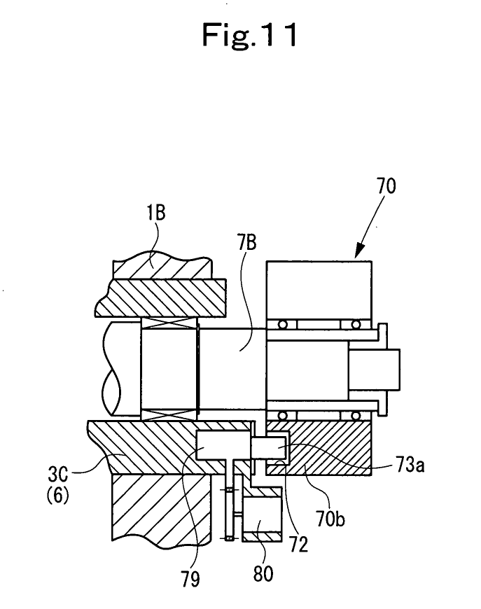

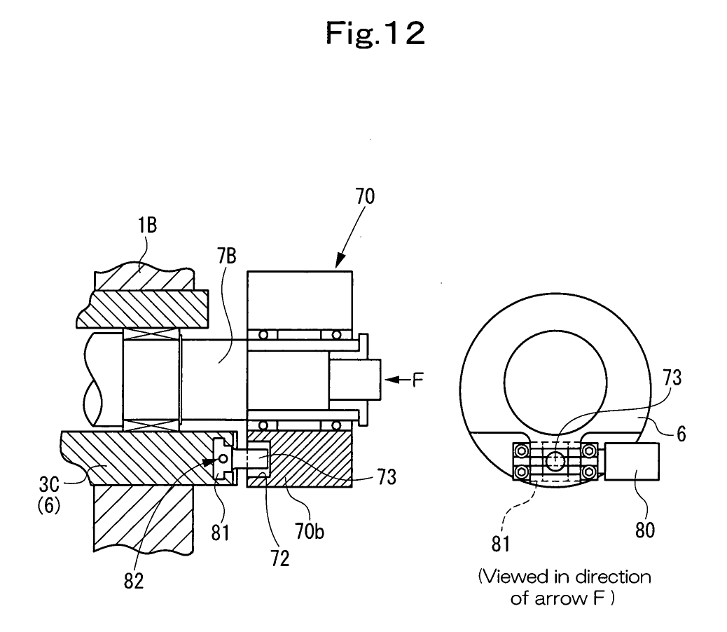

### BRIEF DESCRIPTION OF THE DRAWINGS

[FIG. 1A] is a left half elevational view, developed and partly broken away, of a plate cylinder support portion of a rotary printing press showing Embodiment 1 of the present invention.

[FIG. 1B] is a right half elevational view, developed and partly broken away, of the plate cylinder support portion of the rotary printing press in Embodiment 1.

[FIG. 2A] is a view taken in the direction of an arrow E in FIG. 1A.

[FIG. 2B] is a view taken in the direction of an arrow F in FIG. 1B.

[FIG. 3] is a control block chart.

[FIG. 4A] is a left half elevational view, developed and partly broken away, of a plate cylinder support portion of a rotary printing press showing Embodiment 2 of the present invention.

[FIG. 4B] is a right half elevational view, developed and partly broken away, of the plate cylinder support portion of the rotary printing press in Embodiment 2.

[FIG. 5A] is a left half elevational view, developed and partly broken away, of a plate cylinder support portion of a rotary printing press showing Embodiment 3 of the present invention.

[FIG. 5B] is a right half elevational view, developed and partly broken away, of the plate cylinder support portion of the rotary printing press in Embodiment 3.

[FIG. 6A] is a left half elevational view, developed and partly broken away, of a plate cylinder support portion of a rotary printing press showing Embodiment 4 of the present invention.

[FIG. 6B] is a right half elevational view, developed and partly broken away, of the plate cylinder support portion of the rotary printing press in Embodiment 4.

[FIG. 7A] is a left half elevational view, developed and partly broken away, of a plate cylinder support portion of a rotary printing press showing Embodiment 5 of the present invention.

[FIG. 7B] is a right half elevational view, developed and partly broken away, of the plate cylinder support portion of the rotary printing press in Embodiment 5.

[FIG. 8A] is a left half elevational view, developed and partly broken away, of a plate cylinder support portion of a rotary printing press showing Embodiment 6 of the present invention.

[FIG. 8B] is a right half elevational view, developed and partly broken away, of the plate cylinder support portion of the rotary printing press in Embodiment 6.

[FIG. 9A] is a left half elevational view, developed and partly broken away, of a plate cylinder support portion of a rotary printing press showing Embodiment 7 of the present invention.

[FIG. 9B] is a right half elevational view, developed and partly broken away, of the plate cylinder support portion of the rotary printing press in Embodiment 7.

[FIG. 10A] is a left half elevational view, developed and partly broken away, of a plate cylinder support portion of a rotary printing press showing Embodiment 8 of the present invention.

[FIG. 10B] is a right half elevational view, developed and partly broken away, of the plate cylinder support portion of the rotary printing press in Embodiment 8.

[FIG. 11] is a structural explanation drawing of a plate cylinder support portion showing Embodiment 9 of the present invention.

[FIG. 12] is a structural explanation drawing of a plate cylinder support portion showing Embodiment 10 of the present invention.

### DESCRIPTION OF THE REFERENCE NUMERALS

1A, 1B Frame, 2A, 2B Bearing hole, 3, 3A Outer bearing, 3B, 3C Bearing, 3a Clearance, 4 Inner bearing, 4a Clearance, 4b Engaging projection, 4c Engaging surface, 6 Inner bearing, 6a Clearance, 6b Engaging projection, 6c Engaging surface, 7 Plate Cylinder, 7A, 7B Shaft end, 8 Blanket cylinder, 9 Bearing, 11A, 11B Cylinder, 12A, 12B Rod, 13A, 13B Pivotal attachment site, 15 Motor, 16 Motor shaft, 17 Potentiometer, 18 Gear, 20 Shaft, 21 Gear, 22 Dowel, 23 First lever, 24 Transmission shaft, 24a Small-diameter portion, 24b Large-diameter portion, 25 Supporting member, 26 Second lever, 30 Camshaft, 30a Abutting portion, 31 Bush, 33 Disk, 34 Link member, 35 Lever, 36 Cocking direction, 47 Bracket, 47a Bearing hole, 48 Stay, 49 Worm wheel, 49a Inner peripheral threaded bore, 50 Nut, 51, 52 Thrust bearing, 53 Threaded shaft, 53a Threaded portion, 54 Bolt, 55 Threaded plate, 56 Coupling, 57 Disk, 58 Nut, 59, 60 Thrust bearing, 70 Motor, 70a Rotating portion, 70b Support portion, 71 SPANNRING, 72 Slot, 72a Hole, 73 Pin, 73a Eccentric pin, 74 Synchronous position reference sensor, 75 Detected body for detection of synchronous position, 77 Taper sleeve, 78 Taper piece, 79 Geared rotating body, 80 Synchronization adjusting motor, 81 Slider, 82 Feed screw mechanism, 88 Bearing housing, 89 Worm shaft, 90 Worm wheel, 91 Whirl-stop, 92 Potentiometer, 93 Holder, 94 Helical compression spring, 95 Detector, 96 Pressing body, 97 Motor, 98 Control device, 99 Bracket.

### BEST MODE FOR CARRYING OUT THE INVENTION

A register adjusting apparatus for a rotating body according to the present invention will now be described in detail by embodiments with reference to the accompanying drawings.

### Embodiment 1

FIG. 1A is a left half elevational view, developed and partly broken away, of a plate cylinder support portion of a rotary printing press showing Embodiment 1 of the present invention. FIG. 1B is a right half elevational view, developed and partly broken away, of the plate cylinder support portion of the rotary printing press. FIG. 2A is a view taken in the direction of an arrow E in FIG. 1A. FIG. 2B is a view taken in the direction of an arrow F in FIG. 1B. FIG. 3 is a control block chart.

In FIGS. 1A and 1B, 1A and 1B represent a left frame and a right frame. An outer bearing (one-side cocking eccentric bearing as a cocking eccentric bearing means) 3 is pivotably supported in a bearing hole 2A provided in the left frame 1A, and an inner bearing (one-side throw-on and throw-off eccentric bearing) 4 is pivotably supported by the outer bearing 3.

As shown in FIG. 2A, clearances 3a, 4a to be supplied with a lubricating oil (hereinafter referred to as clearances) are provided between the bearing hole 2A and the outer periphery of the outer bearing 3 and between the inner periphery of the outer bearing 3 and the outer periphery of the inner bearing 4 so that the outer bearing 3 and the inner bearing 4 can smoothly pivot.

As shown in FIG. 1A, an engaging projection 4b having a straightly formed engaging surface 4c abutting on an abutting portion 30a (to be described later) is protrusively provided in a flange portion of the inner bearing 4 in contact with the inside surface of the frame 1A. The direction A of formation of the engaging surface 4c of the engaging projection 4b coincides nearly with the cocking direction 36 of a plate cylinder 7 in which the plate cylinder 7 as a rotating body is moved by operating the outer bearing 3 pivotally (to be described later), as shown in FIG. 2A.

As shown in FIG. 2B, a bearing hole 2B is provided in the right frame 1B, and an inner bearing (opposite-side throw-on and throw-off eccentric bearing) 6 is pivotably supported in the bearing hole 2B. A clearance 6a is provided between the outer periphery of the inner bearing 6 and the bearing hole 2B, as shown in FIG. 2B. An engaging projection 6b having a straightly formed engaging surface 6c abutting on an abutting portion 30a is protrusively provided in a flange portion of the inner bearing 6 in contact with the inside surface of the frame 1B.

In the drawings, the numeral 7 denotes the plate cylinder in contact with a blanket cylinder 8, and the plate cylinder 7 has right and left shaft ends 7A and 7B pivotally supported by the inner bearings 4 and 6 via bearings 9, 9 to be rotatable and movable in the lateral direction (axial direction). The axis C1 of the right and left inner bearings 4 and 6 is eccentric with respect to the axis C of the plate cylinder 7 by t1, while the axis C2 of the outer bearing 3 is eccentric with respect to the axis C1 of the inner bearing 4 by t2.

Right and left cylinders (third drive means) 11A and 11B, as a pair, are pivotally attached to the inside surfaces of the right and left frames 1A and 1B. Rods 12A and 12B of the cylinders 11A and 11B are pivotally attached to the flange portions of the right and left inner bearings 4 and 6 in contact with the inside surfaces of the frames 1A and 1B. Pivotal attachment sites 13A and 13B of the rods 12A and 12B, and the engaging projections 4b and 6b of the inner bearings 4 and 6 are positioned to be nearly 180 degrees phase-shifted, with the axis C of the plate cylinder 7 being located therebetween. The members are configured such that the directions of expansion and retraction of the rods 12A and 12B of the cylinders 11A and 11B are nearly parallel to a line B connecting the axis C of the plate cylinder 7 and the axis C3 of the blanket cylinder 8.

When the rods 12A and 12B of the cylinders 11A and 11B are advanced in such a configuration, as shown in FIGS. 2A and 2B, the right and left inner bearings 4 and 6 pivot about the shaft ends 7A and 7B of the plate cylinder 7, so that the plate cylinder 7 pivots about the axis C1 of the inner bearings 4, 6 as the pivot center. When the engaging projections 4b, 6b abut against the abutting portions 30a, 30a of camshafts 30, 30 (to be described later), the inner bearing 6 slightly pivots clockwise in the drawing about the abutting portion 30a as the pivot center, as shown in FIG. 2B. Thus, a pressing portion, where a part of the outer periphery of the inner bearing 6 presses a part of the inner periphery of the bearing hole 2B of the frame 1B, is formed at a site indicated by the numeral 37 in the drawing. The pressing portion 37 is positioned to rest on an extension of the line B connecting the axis C3 of the blanket cylinder 8 and the axis C of the plate cylinder 7.

As shown in FIG. 2A, the inner bearing 4 slightly pivots counterclockwise in the drawing about the abutting portion 30a as the pivot center. Thus, a pressing portion, where a part of the outer periphery of the inner bearing 4 presses a part of the inner periphery of the outer bearing 3, is formed at a site indicated by the numeral 38 in the drawing. Also, a pressing portion, where a part of the outer periphery of the outer bearing 3 presses a part of the inner periphery of the bearing hole 2A of the frame 1A, is formed at a site indicated by the numeral 39 in the drawing. These pressing portions 38, 39 are positioned to rest on an extension of the line B connecting the axis C3 of the blanket cylinder 8 and the axis C of the plate cylinder 7. The direction D of pressing the bearing hole 2B by the inner bearing 6 at the pressing portion 37 is the same direction as that of the line B. Furthermore, the direction D of pressing the outer bearing 3 by the inner bearing 4, and the direction D of pressing the bearing hole 2A by the outer bearing 3, at the pressing portions 38, 39, are the same direction as that of the line B.

In FIG. 1A, the numeral 15 denotes a motor (first drive means) fixed to the frame 1A via a stud. The motor 15 is equipped with a potentiometer 17 for detecting the rotational speed of a motor shaft 16, and a gear 18 is journaled on the motor shaft 16. The numeral 20 in the drawing denotes a shaft which is rotatable and is restrained from axial movement. A gear 21 meshing with the gear 18 is journaled on the shaft 20, and a dowel 22 is screwed to a threaded portion formed at the top of the shaft 20. The dowel 22 is pivotally attached to one end portion of a first lever 23. The numeral 24 denotes a transmission shaft provided with a small-diameter portion 24a and a large-diameter portion 24b eccentric with respect to each other. The transmission shaft 24 is pivotably supported by a supporting member 25 fixed to the frame 1A, and the small-diameter portion 24a is fitted into and fixed in a hole provided in an opposite end portion of the first lever 23.

The large-diameter portion 24b of the transmission shaft 24 is fitted into and fixed in a hole provided in an end portion of a second lever 26, and an opposite end portion of the second lever 26 is pivotally attached to the flange portion of the outer bearing 3. Thus, when the motor 15 is driven, and the rotation of the motor shaft 16 is transmitted to the shaft 20 via the gears 18, 21, the first lever 23 is pivoted via the dowel 22 about the transmission shaft 24 as the pivot center, with the result that the transmission shaft 24 is also pivoted integrally. The pivoting of the transmission shaft 24 is transmitted to the second lever 26 via the large-diameter portion 24b, and the second lever 26 is moved in the direction of a double-headed arrow in the drawing, as shown in FIG. 2A. Thus, the outer bearing 3 is pivoted clockwise or counterclockwise in the drawing. Since the outer bearing 3 is pivoted in this manner, the plate cylinder 7 is moved in the cocking direction (tilting direction) indicated by the arrow 36 in the drawing, because the axis C2 of the outer bearing 3 is eccentric relative to the axis C1 of the inner bearing 4.

In FIGS. 1A and 1B, the numeral 30 denotes the camshaft, which is pivotably supported via a bush 31 in a hole bored in each of the right and left frames 1A and 1B. The eccentric cam-shaped abutting portion 30a is provided in an end portion of the camshaft 30 protruding from the inside of the right or left frame 1A or 1B. The numeral 33 in the drawing denotes a disk pivotably supported by a bearing of a blanket cylinder (not shown). The disk 33 is arranged to have its pivoting adjustable by an operating member (not shown). An end portion of a link member 34 is pivotally attached to the disk 33, and an end portion of a lever 35 is pivotally attached to the opposite end portion of the link member 34. An opposite end portion of the lever 35 is journaled on an opposite end portion of the camshaft 30 protruding from the outside of the right or left frame 1A or 1B. Thus, when the pivoting of the disk 33 is adjusted, the camshaft 30 is pivoted via the link member 34 and the lever 35. As a result, as shown in FIGS. 2A and 2B, the positions of the engaging projections 4b, 6b of the inner bearings 4, 6 abutting against the abutting portions 30a are adjusted, whereby nip pressure (contact pressure) between the plate cylinder 7 and the blanket cylinder 8 is adjusted (center-to-center adjustment).

As shown in FIG. 1A, a bracket 47 formed in a nearly triangular shape is provided outwardly of the frame 1A parallel to the frame 1A, with a plurality of stays 48 connecting the bracket 47 and the frame 1A. A stepped worm wheel 49 is fitted into a bearing hole 47a of the bracket 47, and is clamped and fixed by a nut 50 screwed to a threaded front end portion of the worm wheel 49. The numerals 51, 52 in the drawing denote thrust bearings which pinch the bracket 47 and which are interposed on both sides of the bracket 47.

A threaded portion 53a of a threaded shaft 53 having a flange is screwed to an inner peripheral threaded bore 49a of the worm wheel 49. A threaded plate 55 fixed to the worm wheel 49 by slots and bolts 54 is screwed to the front end of the threaded portion 53a. In the drawing, the numeral 56 denotes a coupling bonded to the shaft end 7A of the plate cylinder 7 by bolts 45, 46, and a disk 57 is screwed to one of opening ends of the coupling. One end of the threaded shaft 53 is fitted into an inner hole of the disk 57, and is set in place by its flange and a nut 58. In the drawing, the numerals 59, 60 denote thrust bearings held by the flange, the nut 58, and the disk 57. Being so configured, the threaded shaft 53 and the coupling 56 are pivotable with respect to each other and are restrained from axial movement.

A bearing housing 88 formed in the shape of an upwardly open box is fixed to the bracket 47, and a worm 90 meshing with the worm wheel 49 is journaled on a worm shaft 89 pivotally supported by the bearing housing 88. The worm shaft 89 is coupled to a motor 97 (second drive means) via a joint, as appropriate. Because of such a configuration, when the worm shaft 89 is pivoted to pivot the threaded shaft 53, the threaded shaft 53 is moved axially by the thread action of the threaded portion 53a. As a result, the plate cylinder 7, which is axially integral with the threaded shaft 53 via the coupling 56, moves in the axial direction, whereby register in the lateral direction is adjusted. In the drawing, the numeral 91 denotes a whirl-stop which is fixed to the bearing housing 88 and has a lower end flat surface brought into contact with a tip chamfered surface 53b of the threaded shaft 53 to restrain the pivoting of the threaded shaft 53.

A potentiometer 92 of a linear displacement type, which parallels the plate cylinder 7 and is electrically connected to a display panel (not shown), is fixed via a holder 93 to a lower end portion of the bracket 47. The potentiometer 92 is equipped with a detector 95 which is urged in the extension direction by the resilient force of a helical compression spring 94. In the drawing, the numeral 96 denotes a pressing body which is fixed upright to the tip flat surface of the threaded shaft 53. The pressing body 96 has a lower end vertical flat surface in contact with the end surface of the detector 95. When the threaded shaft 53 is axially moved upon lateral register adjustment, the pressing body 96 advances or retreats the detector 95 in cooperation with the helical compression spring 94 to display the amount of lateral register adjustment on the panel.

As shown in FIG. 1B, a motor 70 for rotationally driving the plate cylinder 7 is assembled to the shaft end 7B of the plate cylinder 7 on the side of the frame 1B. The motor 70 is composed of a tubular rotating portion 70a fitted on the outer periphery of the shaft end 7B of the plate cylinder 7, and a tubular support portion (flange portion) 70b pivotably fitted on the outer periphery of the rotating portion 70a. The rotating portion 70a is integrated with the shaft end 7B of the plate cylinder 7 by SPANNRING (wedge-shaped friction engagement element: a trade name of RINGFEDER) 71. On the other hand, the support portion 70b has a slot (optionally, a long groove) 72, as an engaged portion, elongated in its diametrical direction, and has the slot 72 engaged with a pin 73, as an engaging portion, protruding at the end surface of the inner bearing 6 for the purpose of whirl-stopping. Alternatively, the pin 73 may be provided in the support portion 70b, and the slot (or long groove) 72 may be provided in the inner bearing 6.

The slot 72 permits the lateral movement of the plate cylinder 7 in the range of a depth dimension L₁, and allows cocking (tilting) of the plate cylinder 7 in the range a major-axis dimension L₂. In the drawing, the numeral 74 denotes a synchronous position reference sensor fixed to the frame 1B via a bracket, and the numeral 75 denotes a detected body for synchronous position detection which is secured to the shaft end 7B of the plate cylinder 7. Because of such a configuration, the synchronous position (motor home position) of the motor 70 (strictly, the rotating portion 70a) is variably controlled by a control device (control means) 98, which comprises a microcomputer or the like, as shown in FIG. 3. By so doing, the rotation phase of the plate cylinder 7 relative to the blanket cylinder 8 is shifted, whereby register in the circumferential direction is adjusted. Moreover, it becomes possible to correct a shift in the rotation phase during throw-on and throw-off, center-to-center adjustment, or cocking (to be described later). Thus, the synchronous position reference sensor 74 and the control device 98 constitute a phase difference correction means.

In connection with the above configuration, a description will be first offered of the throw-on and throw-off actions of the plate cylinder 7 with respect to the blanket cylinder 8 in the cylinder device of the rotary printing press.

When the rods 12A, 12B of the cylinders 11A, 11B are advanced, the right and left inner bearings 4, 6 are pivoted about the shaft ends 7A, 7B of the plate cylinder 7, as stated earlier. Thus, the plate cylinder 7 is pivoted about the axis C1 of the inner bearings 4, 6 as the pivot center. The engaging projections 4b, 6b abut against the abutting portions 30a, 30a of the camshafts 30, 30 (to be described later), whereby the inner bearing 4 is pressed against the outer bearing 3 at the pressing portion 38. Also, the outer bearing 3 and the inner bearing 6 are pressed against the bearing holes 2A, 2B at the pressing portions 39, 37, so that the plate cylinder 7 contacts the blanket cylinder 8 at a proper nip pressure.

Thus, notches provided in the outer peripheries of the plate cylinder 7 and the blanket cylinder 8 oppose each other during printing, and then the outer periphery of the plate cylinder 7 and the outer periphery of the blanket cylinder 8 contact each other again, so that the plate cylinder 7 is about to move slightly in the diametrical direction of the blanket cylinder 8. Since the pressing portions 37, 38, 39 are formed, however, this movement is inhibited. Thus, the occurrence of vibration in the plate cylinder 7 and the blanket cylinder 8 due to such movement is restrained, so that printing failure can be prevented.

Furthermore, the pressing portions 37, 38, 39 are positioned to be located on the extension of the line B connecting the axis C3 of the blanket cylinder 8 and the axis C of the plate cylinder 7. At the pressing portion 37, the direction D of pressing the bearing hole 2B by the inner bearing 6 is the same direction as that of the line B. At the pressing portions 38, 39, the direction D of pressing the outer bearing 3 by the inner bearing 4, and the direction D of pressing the bearing hole 2A by the outer bearing 3 are the same direction as that of the line B. Thus, the direction of movement of the plate cylinder 7 due to the notches of the plate cylinder 7 and the blanket cylinder 8, as mentioned above, is a direction from the axis C of the plate cylinder 7 toward the axis C3 of the blanket cylinder 8, namely, a direction opposite to the above-mentioned pressing direction D. Thus, the movement of the plate cylinder 7 is restrained, so that printing failure can be prevented reliably.

During the above-mentioned throw-on state of the plate cylinder 7, the home position (synchronous position) of the motor 70 is set. Conversely, during the throw-off state of the plate cylinder 7 where the rods 12A, 12B of the cylinders 11A, 11B retract, the support portion 70b of the motor 70 turns together with the inner bearing 6 to change the home position of the motor 70, since the pin 73 is fixed to the inner bearing 6. However, no problem is posed, because printing is not done during this state.

Center-to-center adjustment for adjusting the nip pressure (contact pressure) between the plate cylinder 7 and the blanket cylinder 8 is made by pivoting the disk 33 to adjust the positions of the engaging projections 4b, 6b of the inner bearings 4,6 abutting against the abutting portion 30a. During this center-to-center adjustment, the support portion 70b of the motor 70 turns together with the inner bearing 6 to change the home position of the motor 70, since the pin 73 is fixed to the inner bearing 6. In the present embodiment, however, the motor 70 can be returned to the home position by the aforementioned phase difference correction means (see FIG. 3), thus posing no problem. The change in the home position can be dealt with by correcting the home position of the motor 70 by an amount corresponding to the angle of rotation of the bearing with the use of the control system, without using the synchronous position reference sensor 74 or the like.

If adjustment of the cocking direction of the plate cylinder 7 is necessary, the motor 15 is driven. As a result, the rotation of the motor shaft 16 is transmitted to the shaft 20 via the gears 18, 21, and the first lever 23 is pivoted about the transmission shaft 24 as the pivot center via the dowel 22. Thus, the transmission shaft 24 also pivots integrally. Pivoting of the transmission shaft 24 is transmitted to the second lever 26 via the large-diameter portion 24b, and the second lever 26 moves in the direction of the arrow, as shown in FIG. 2A. Thus, the outer bearing 3 is pivoted clockwise or counterclockwise in the drawing, so that the plate cylinder 7 moves in the cocking direction indicated by the arrow 36 in the drawing. At this time, the cocking direction 36 of the plate cylinder 7 nearly coincides with the direction A of formation of the engaging surface 4c of the engaging projection 4b. During cocking adjustment, therefore, the positional relation between the inner bearing 4 and the shaft end 7A of the plate cylinder 7 does not change. Thus, the nip pressure of the plate cylinder 7 with respect to the blanket cylinder 8 is maintained at a proper value.

On this occasion, the slot 72 provided in the support portion 70b of the motor 70 allows cocking of the plate cylinder 7 within the range of the major axis dimension L₂, thus avoiding malfunction due to interference or the like between the members.

If the lateral adjustment of the plate cylinder 7 is necessary, the worm shaft 89 coupled to the output shaft of the motor 97 pivots to pivot the threaded shaft 53. Under the thread action of the threaded portion 53a, the threaded shaft 53 moves in the axial direction. The plate cylinder 7 axially integral with the threaded shaft 53 via the coupling 56 moves in the axial direction to adjust lateral register.

On this occasion, the slot 72 provided in the support portion 70b of the motor 70 allows the lateral movement of the plate cylinder 7 within the range of the depth dimension L₁, thus avoiding malfunction due to collision or the like between the members.

If the circumferential adjustment of the plate cylinder 7 is required, the synchronous position (motor home position) of the motor 70 (rotating portion 70a) is changed by the control system, as stated earlier. By so doing, the rotation phase of the plate cylinder 7 relative to the blanket cylinder 8 is shifted to adjust circumferential register.

In the present embodiment, as described above, the motor driving of the plate cylinder 7 can be performed, and various register adjustments can be made easily, by an inexpensive mechanical configuration in which the support portion 70b of the motor 70 is whirl-stopped by the slot 72 and the pin 73.

### Embodiment 2

FIG. 4A is a left half elevational view, developed and partly broken away, of a plate cylinder support portion of a rotary printing press showing Embodiment 2 of the present invention. FIG. 4B is a right half elevational view, developed and partly broken away, of the plate cylinder support portion of the rotary printing press.

This is an embodiment in which an outer bearing (opposite-side cocking eccentric bearing) 3A similar to that in Embodiment 1 is also provided on the side of the other shaft end 7B of the plate cylinder 7.

Detailedly, in FIG. 4B, the numeral 15 denotes a motor (first drive means) fixed to the frame 1B via a stud. The motor 15 is equipped with a potentiometer 17 for detecting the rotational speed of a motor shaft 16, and a gear 18 is journaled on the motor shaft 16. The numeral 20 in the drawing denotes a shaft which is rotatable and is restrained from axial movement. A gear 21 meshing with the gear 18 is journaled on the shaft 20, and a dowel 22 is screwed to a threaded portion formed at the top of the shaft 20. The dowel 22 is pivotally attached to one end portion of a first lever 23. The numeral 24 denotes a transmission shaft provided with a small-diameter portion 24a and a large-diameter portion 24b eccentric with respect to each other. The transmission shaft 24 is pivotably supported by a supporting member 25 fixed to the frame 1B, and the small-diameter portion 24a is fitted into and fixed in a hole provided in an opposite end portion of the first lever 23.

The large-diameter portion 24b of the transmission shaft 24 is fitted into and fixed in a hole provided in an end portion of a second lever 26, and an opposite end portion of the second lever 26 is pivotally attached to the flange portion of the outer bearing 3A. Thus, when the motor 15 is driven, and the rotation of the motor shaft 16 is transmitted to the shaft 20 via the gears 18, 21, the first lever 23 is pivoted via the dowel 22 about the transmission shaft 24 as the pivot center, with the result that the transmission shaft 24 is also pivoted integrally. The pivoting of the transmission shaft 24 is transmitted to the second lever 26 via the large-diameter portion 24b, and the second lever 26 is reciprocated, whereby the outer bearing 3A is pivoted in a reciprocating manner. Since the outer bearing 3A undergoes reciprocating pivoting in this manner, the plate cylinder 7 is moved in a cocking direction (tilting direction), because the axis of the outer bearing 3A is eccentric relative to the axis of the inner bearing 6. The other features are the same as those in Embodiment 1. Thus, the same members as those in FIGS. 1A and 1B are assigned the same numerals and symbols as those in these drawings, and duplicate explanations are omitted.

According to the above-described configuration, in addition to the same actions and effects as those in Embodiment 1, the advantage that greater cocking adjustment can be made is obtained by reversing the action (rotating direction of the motor, etc.) of the motor 15 on the side of the one outer bearing 3, and the action of the motor 15 on the other outer bearing 3A with respect to each other.

### Embodiment 3

FIG. 5A is a left half elevational view, developed and partly broken away, of a plate cylinder support portion of a rotary printing press showing Embodiment 3 of the present invention. FIG. 5B is a right half elevational view, developed and partly broken away, of the plate cylinder support portion of the rotary printing press.

This is an embodiment in which the inner bearings 4, 6 for throw-on and throw-off and center-to-center adjustment in Embodiment 1 are omitted, one shaft end 7A of a plate cylinder 7 is supported by a bearing 3B (corresponding to one of the outer bearings, 3, in Embodiment 1), as a one-side cocking eccentric bearing, via a bearing 9, while the other shaft end 7B of the plate cylinder 7 is supported by a bearing hole 2B of a frame 1B via a bearing 9, and a pin 73, as an engaging portion for fixing a support portion 70b of a motor 70, is planted in the frame 1B.

In the present embodiment, the pin 73, as the engaging portion for fixing the support portion 70b of the motor 70, is planted in the frame 1B. Even if the bearing 3B pivots in a reciprocating manner, therefore, no shift in rotation phase occurs between the plate cylinder 7 and the motor 70. This obviates the necessity for the phase difference correction means in Embodiment 1. The other features are the same as those in Embodiment 1. Thus, the same members as those in FIGS. 1A and 1B are assigned the same numerals and symbols as those in these drawings, and duplicate explanations are omitted.

According to the present embodiment, the throw-on and throw-off and center-to-center adjustment functions of the plate cylinder 7 are not obtained, but other functions identical with the actions and effects of Embodiment 1 are obtained. In this case, throw-on and throw-off and center-to-center adjustment functions are imparted to the blanket cylinder.

### Embodiment 4

FIG. 6A is a left half elevational view, developed and partly broken away, of a plate cylinder support portion of a rotary printing press showing Embodiment 4 of the present invention. FIG. 6B is a right half elevational view, developed and partly broken away, of the plate cylinder support portion of the rotary printing press.

This is an embodiment in which the slot 72, as the engaged portion, of the motor 70 in Embodiment 3 is formed in a bracket 99, and a pin 73, as an engaging portion, planted in a frame 1B is engaged with the slot 72 of the bracket 99. The other features are the same as those in Embodiment 3. Thus, the same members as those in FIGS. 5A and 5B are assigned the same numerals and symbols as those in these drawings, and duplicate explanations are omitted.

According to the present embodiment, the same actions and effects as those in Embodiment 3 are obtained.

### Embodiment 5

FIG. 7A is a left half elevational view, developed and partly broken away, of a plate cylinder support portion of a rotary printing press showing Embodiment 5 of the present invention. FIG. 7B is a right half elevational view, developed and partly broken away, of the plate cylinder support portion of the rotary printing press.

This is an embodiment in which the same bearing (opposite-side cocking eccentric bearing) 3C as that in Embodiments 3 and 4 is also provided on the side of the other shaft end 7B of the plate cylinder 7, and a pin 73, as an engaging portion, for fixing a support portion 70b of a motor 70 is planted in the bearing 3C.

Detailedly, in FIG. 7B, the numeral 15 denotes a motor (first drive means) fixed to a frame 1B via a stud. The motor 15 is equipped with a potentiometer 17 for detecting the rotational speed of a motor shaft 16, and a gear 18 is journaled on the motor shaft 16. The numeral 20 in the drawing denotes a shaft which is rotatable and is restrained from axial movement. A gear 21 meshing with the gear 18 is journaled on the shaft 20, and a dowel 22 is screwed to a threaded portion formed at the top of the shaft 20. The dowel 22 is pivotally attached to one end portion of a first lever 23. The numeral 24 denotes a transmission shaft provided with a small-diameter portion 24a and a large-diameter portion 24b eccentric with respect to each other. The transmission shaft 24 is pivotably supported by a supporting member 25 fixed to the frame 1B, and the small-diameter portion 24a is fitted into and fixed in a hole provided in an opposite end portion of the first lever 23.

The large-diameter portion 24b of the transmission shaft 24 is fitted into and fixed in a hole provided in an end portion of a second lever 26, and an opposite end portion of the second lever 26 is pivotally attached to the flange portion of the outer bearing 3C. Thus, when the motor 15 is driven, and the rotation of the motor shaft 16 is transmitted to the shaft 20 via the gears 18, 21, the first lever 23 is pivoted via the dowel 22 about the transmission shaft 24 as the pivot center, with the result that the transmission shaft 24 is also pivoted integrally. The pivoting of the transmission shaft 24 is transmitted to the second lever 26 via the large-diameter portion 24b, and the second lever 26 is reciprocated, whereby the bearing 3C is pivoted in a reciprocating manner. Since the bearing 3C undergoes reciprocating pivoting in this manner, the plate cylinder 7 is moved in a cocking direction (tilting direction), because the axis of the bearing 3C is eccentric relative to the axis of the plate cylinder 7.

In the present embodiment, moreover, the pin 73, as the engaging portion, for fixing the support portion 70b of the motor 70 is planted in the bearing 3C. Thus, a shift in rotation phase occurs between the plate cylinder 7 and the motor 70 during pivoting of the bearing 3C. Hence, the phase difference correction means in Embodiment 1 is provided. The other features are the same as those in Embodiments 3 and 4. Thus, the same members as those in FIGS. 5A, 5B and FIGS. 6A, 6B are assigned the same numerals and symbols as those in these drawings, and duplicate explanations are omitted.

According to the above-described configuration, in addition to the same actions and effects as those in Embodiments 3 and 4, the advantage that greater cocking adjustment can be made is obtained by reversing the action (rotating direction of the motor, etc.) of the motor 15 on the side of one bearing 3B, and the action of the motor 15 on the side of the other bearing 3C with respect to each other.

### Embodiment 6

FIG. 8A is a left half elevational view, developed and partly broken away, of a plate cylinder support portion of a rotary printing press showing Embodiment 6 of the present invention. FIG. 8B is a right half elevational view, developed and partly broken away, of the plate cylinder support portion of the rotary printing press.

This is an embodiment in which the slot 72, as the engaged portion, of the motor 70 in Embodiment 5 is formed in a bracket 99, and a pin 73, as an engaging portion, planted in a frame 1B is engaged with the slot 72 of the bracket 99. The other features are the same as those in Embodiment 5. Thus, the same members as those in FIGS. 7A and 7B are assigned the same numerals and symbols as those in these drawings, and duplicate explanations are omitted.

According to the present embodiment, the same actions and effects as those in Embodiment 5 are obtained.

### Embodiment 7

FIG. 9A is a left half elevational view, developed and partly broken away, of a plate cylinder support portion of a rotary printing press showing Embodiment 7 of the present invention. FIG. 9B is a right half elevational view, developed and partly broken away, of the plate cylinder support portion of the rotary printing press.

This is an embodiment in which the bearing 3B, as the one-side cocking eccentric bearing, in Embodiment 3 is omitted, one shaft end 7A of a plate cylinder 7 is supported by a bearing hole 2A of a frame 1A via a bearing 9, and a pin 73 planted in a frame 1B is engaged with a circular hole (or groove) 72a formed in a support portion 70b of a motor 70. The other features are the same as those in Embodiment 3. Thus, the same members as those in FIGS. 5A and 5B are assigned the same numerals and symbols as those in these drawings, and duplicate explanations are omitted.

According to the present embodiment, the throw-on and throw-off, center-to-center adjustment and cocking functions of the plate cylinder 7 are not obtained, but functions, such as the lateral movement of the plate cylinder 7, are obtained as in Embodiment 3.

### Embodiment 8

FIG. 10A is a left half elevational view, developed and partly broken away, of a plate cylinder support portion of a rotary printing press showing Embodiment 8 of the present invention. FIG. 10B is a right half elevational view, developed and partly broken away, of the plate cylinder support portion of the rotary printing press.

This is an embodiment in which the circular hole (or groove) 72a, as the engaged portion, of the motor 70 in Embodiment 7 is formed in a bracket 99, and a pin 73, as an engaging portion, planted in a frame 1B is engaged with the circular hole (or groove) 72a of the bracket 99. The other features are the same as those in Embodiment 7. Thus, the same members as those in FIGS. 9A and 9B are assigned the same numerals and symbols as those in these drawings, and duplicate explanations are omitted.

According to the present embodiment, the same actions and effects as those in Embodiment 7 are obtained.

### Embodiment 9

FIG. 11 is a structural explanation drawing of a motor whirl-stop portion showing Embodiment 9 of the present invention.

This is an embodiment in which an eccentric pin 73a engaged into the slot (or long groove) 72 formed in the support portion (flange portion) 70b of the motor 70 in Embodiments 1, 2 and 5 is provided in a geared rotating body 79 pivotable within a bearing 3C (or an inner bearing 6), and the rotating body 79 is rotated by gear driving of a synchronization adjusting motor 80 similarly integrally supported by the bearing 3C (or inner bearing 6) to pivot the support portion (flange portion) 70b via the eccentric pin 73a, thereby shifting the rotation phase of the plate cylinder 7 with respect to other cylinder, so that circumferential register adjustment can be made.

According to the present embodiment, moreover, when the motor home position is changed upon rotation of the bearing 3C (or inner bearing 6) during the aforementioned cocking or center-to-center adjustment, the synchronization adjusting motor 80 is driven by an amount corresponding to the angle of rotation of the bearing, whereby the motor home position can be returned to the original.

### Embodiment 10

FIG. 12 is a structural explanation drawing of a plate cylinder support portion showing Embodiment 10 of the present invention.

This is an embodiment in which a pin 73 engaged into the slot (long groove) 72 formed in the support portion (flange portion) 70b of the motor 70 in Embodiments 1, 2 and 5 is provided in a slider 81 slidable in a longitudinal direction within a bearing 3C (or inner bearing 6), and the slider 81 is slid by a synchronization adjusting motor 80 via a feed screw mechanism 82 to pivot the support portion (flange portion) 70b via the pin 73, thereby shifting the rotation phase of the plate cylinder 7 with respect to other cylinder, so that circumferential register adjustment can be made.

According to the present embodiment, moreover, when the motor home position is changed upon rotation of the bearing 3C (or inner bearing 6) during the aforementioned cocking or center-to-center adjustment, the synchronization adjusting motor 80 is driven by an amount corresponding to the angle of rotation of the bearing, whereby the motor home position can be returned to the original.

### INDUSTRIAL APPLICABILITY

It goes without saying that the present invention is not limited to the above embodiments, and various changes and modifications may be made without departing from the gist of the present invention. For example, the examples of using the apparatus for the plate cylinder as the rotating body are disclosed as the above embodiments. However, the apparatus can be applied to cylinders, such as a blanket cylinder, an impression cylinder, a transfer cylinder, a numbering cylinder, and a rotary screen cylinder, rollers, such as a rubber roller, an ink fountain roller, and an oscillating roller, and a drive shaft. Moreover, the examples of using the columnar pin 73 and the eccentric pin 73a as the engaging portions are disclosed, but these pins may be square in shape, and may be of any shape.

1. A register adjusting apparatus for a rotating body, comprising:
cocking eccentric bearing means for supporting at least a one-side shaft of said rotating body;
first drive means for pivoting said cocking eccentric bearing means;
a motor, provided on a shaft portion of said rotating body, for rotationally driving said rotating body; and
an engaging portion engaging an engaged portion of said motor, and
wherein said engaged portion permits movement of said motor in accordance with movement of said rotating body which is moved in a cocking direction by driving of said first drive means located on said one side.

2. The register adjusting apparatus for a rotating body according to claim 1, wherein
said cocking eccentric bearing means is composed of one-side and opposite-side cocking eccentric bearings for supporting said one-side shaft and an opposite-side shaft of said rotating body, and
which further comprises said first drive means located on one side and an opposite side for pivoting said one-side and opposite-side cocking eccentric bearings.

3. The register adjusting apparatus for a rotating body according to claim 1, wherein
said cocking eccentric bearing means is a one-side cocking eccentric bearing for supporting said one-side shaft, and
which further comprises
a one-side throw-on and throw-off eccentric bearing supporting said one-side shaft of said rotating body and supported by said one-side cocking eccentric bearing,
an opposite-side throw-on and throw-off eccentric bearing for supporting said opposite-side shaft of said rotating body, and
third drive means for pivoting said one-side throw-on and throw-off eccentric bearing and said opposite-side throw-on and throw-off eccentric bearing.

4. The register adjusting apparatus for a rotating body according to claim 2, further comprising
a one-side throw-on and throw-off eccentric bearing supporting said one-side shaft of said rotating body and supported by said one-side cocking eccentric bearing,
an opposite-side throw-on and throw-off eccentric bearing supporting said opposite-side shaft of said rotating body and supported by said opposite-side cocking eccentric bearing, and
third drive means for pivoting said one-side throw-on and throw-off eccentric bearing and said opposite-side throw-on and throw-off eccentric bearing.

5. The register adjusting apparatus for a rotating body according to claim 1, wherein said engaged portion is moved with respect to said engaging portion by said first drive means.

6. The register adjusting apparatus for a rotating body according to claim 5, wherein said motor includes
a rotating portion rotated by a drive action, and
a support portion supporting said rotating portion and having said engaged portion formed therein.

7. The register adjusting apparatus for a rotating body according to claim 6, wherein said engaged portion is restrained by said engaging portion to prevent rotation of said support portion.

8. The register adjusting apparatus for a rotating body according to claim 7, wherein
said engaged portion is a slot or a long groove or a pin, and
said engaging portion is a pin engaging into said slot or said long groove, or is a slot or a long groove which said pin engages.

9. The register adjusting apparatus for a rotating body according to claim 8, wherein
said slot or said long groove has a major axis dimension in a moving direction of said rotating body moved by an action of said first drive means.

10. The register adjusting apparatus for a rotating body according to claim 3, wherein said motor includes
a rotating portion rotated by a drive action, and
a support portion supporting said rotating portion and having said engaged portion formed therein, and
which further comprises phase difference correction means for correcting a rotation phase shift of said rotating body caused by pivoting of said one-side and opposite-side throw-on and throw-off eccentric bearings in accordance with an action of said third drive means.

11. The register adjusting apparatus for a rotating body according to claim 1, wherein said motor includes
a rotating portion rotated by a drive action, and
a support portion supporting said rotating portion and having said engaged portion formed therein, and
which further comprises phase difference correction means for correcting a rotation phase shift of said rotating body caused by pivoting of said cocking eccentric bearing means in accordance with an action of said first drive means.

12. The register adjusting apparatus for a rotating body according to claim 10, wherein said phase difference correction means comprises
a sensor for detecting a phase of said rotating body, and
control means for controlling said motor based on a detection signal of said sensor.

13. The register adjusting apparatus for a rotating body according to claim 10, wherein
said motor is provided on said opposite-side shaft of said rotating body, and has a slot or a long groove formed in said support portion,
an eccentric pin is provided which is pivotably supported by said opposite-side throw-on and throw-off eccentric bearing and which engages said slot or said long groove, and
said phase difference correction means comprises
a sensor for detecting a phase of said rotating body,
a motor for pivoting said eccentric pin, and
control means for controlling said motor based on a detection signal of said sensor.

14. The register adjusting apparatus for a rotating body according to claim 11, wherein
said motor is provided on said opposite-side shaft of said rotating body, and has a slot or a long groove formed in said support portion,
an eccentric pin is provided which is pivotably supported by said opposite-side cocking eccentric bearing and which engages said slot or said long groove, and
said phase difference correction means comprises
a sensor for detecting a phase of said rotating body,
a motor for pivoting said eccentric pin, and
control means for controlling said motor based on a detection signal of said sensor.

15. The register adjusting apparatus for a rotating body according to claim 10, wherein
said motor is provided on said opposite-side shaft of said rotating body, and has a slot or a long groove formed in said support portion,
a pin is provided which has a proximal end portion slidably supported by said opposite-side throw-on and throw-off eccentric bearing and which engages said slot or said long groove, and
said phase difference correction means comprises
a sensor for detecting a phase of said rotating body,
a motor for moving said pin, and
control means for controlling said motor based on a detection signal of said sensor.

16. The register adjusting apparatus for a rotating body according to claim 11, wherein
said motor is provided on said opposite-side shaft of said rotating body, and has a slot or a long groove formed in said support portion,
a pin is provided which has a proximal end portion slidably supported by said opposite-side cocking eccentric bearing and which engages said slot or said long groove, and
said phase difference correction means comprises
a sensor for detecting a phase of said rotating body,
a motor for pivoting said pin, and
control means for controlling said motor based on a detection signal of said sensor.

17. A register adjusting apparatus for a rotating body, comprising:
a pair of bearings for rotatably supporting opposite end portions of a rotating body;
a motor, provided on a shaft portion of said rotating body beside said bearing on an opposite side, for rotationally driving said rotating body;
second drive means, provided beside said bearing on one side, for moving said rotating body, together with said motor, in an axial direction; and
an engaging portion provided on said bearing on said opposite side, and engaging an engaged portion of said motor, and
wherein said engaged portion permits movement of said rotating body which is moved in the axial direction when driven by said second drive means.

18. The register adjusting apparatus for a plate cylinder according to claim 17, wherein said engaged portion is moved with respect to said engaging portion by said second drive means.

19. The register adjusting apparatus for a plate cylinder according to claim 17, wherein said engaged portion is moved with respect to said engaging portion by said second drive means, with said engaged portion being engaged with said engaging portion.

20. The register adjusting apparatus for a rotating body according to claim 17, wherein
said pair of bearings are a pair of throw-on and throw-off eccentric bearings eccentric with respect to said rotating body, and
which further comprises third drive means for pivoting said pair of throw-on and throw-off eccentric bearings.

21. The register adjusting apparatus for a rotating body according to claim 18, wherein said motor includes
a rotating portion rotated by a drive action, and
a support portion supporting said rotating portion and having said engaged portion formed therein.

22. The register adjusting apparatus for a rotating body according to claim 21, wherein said engaged portion is restrained by said engaging portion to prevent rotation of said support portion.

23. The register adjusting apparatus for a rotating body according to claim 22, wherein
said engaged portion is a hole or a groove or a pin, and
said engaging portion is a pin engaging into said hole or said groove, or is a hole or a groove which said pin engages.

24. The register adjusting apparatus for a rotating body according to claim 20, wherein said motor includes
a rotating portion rotated by a drive action, and
a support portion supporting said rotating portion and having said engaged portion formed therein, and
which further comprises phase difference correction means for correcting a rotation phase shift of said rotating body caused by pivoting of said pair of throw-on and throw-off eccentric bearings in accordance with an action of said third drive means.

25. The register adjusting apparatus for a rotating body according to claim 24, wherein said phase difference correction means comprises
a sensor for detecting a phase of said rotating body, and
control means for controlling said motor based on a detection signal of said sensor.

26. The register adjusting apparatus for a rotating body according to claim 25, wherein
said motor is provided on said opposite-side shaft of said rotating body, and has a hole or a groove formed in said support portion,
an eccentric pin is provided which is pivotably supported by said opposite-side throw-on and throw-off eccentric bearing and which engages said hole or said groove, and
said phase difference correction means comprises
a sensor for detecting a phase of said rotating body,
a motor for pivoting said eccentric pin, and
control means for controlling said motor based on a detection signal of said sensor.

27. The register adjusting apparatus for a rotating body according to claim 24, wherein
said motor is provided on said opposite-side shaft of said rotating body, and has a hole or a groove formed in said support portion,
a pin is provided which has a proximal end portion slidably supported by said opposite-side throw-on and throw-off eccentric bearing and which engages said hole or said groove, and
said phase difference correction means comprises
a sensor for detecting a phase of said rotating body,
a motor for pivoting said pin, and
control means for controlling said motor based on a detection signal of said sensor.
